(19) United States
(12) Patent Application Publication
(10) Pub. No.: US 2009/0029304 A1
(43) Pub. Date: Jan. 29, 2009

(54) Adjustable height candle holder jar

(76) Inventors: Ronald A. Steinmann, Islip, NY (US); Nicholas Legakis, West Islip, NY (US); Loretta M. Legakis, West Islip, NY (US); Linda Edwards, Islip, NY (US)

Correspondence Address: ALFRED M. WALKER, 225 OLD COUNTRY ROAD, MELVILLE, NY, 11747-2712, US

(21) Appl. No.: 12/218,603

(22) Filed: Jul. 16, 2008

Related U.S. Application Data
(60) Provisional application No. 60/961,296, filed on Jul. 20, 2007.

(51) Int. Cl. F21V 35/00

(52) U.S. Cl. 431/289

(57) ABSTRACT

An adjustable height holder jar for consumable items includes a stack of accurately fitted rings forming the side atop a closed bottom section. The jar is intended to be factory filled with scented candle wax with a typical wick in the center or with a collection of consumable items, such as food item pieces or hardware fasteners, such as screws or nails.

### FIELD OF THE INVENTION

The present invention relates to height adjustable containers for consumable objects, such as candles.

### BACKGROUND OF THE INVENTION

Tall jars of scented wax candles are popular gift and decorating items. In operation, the wick is simply lighted within the jar in which it was purchased as the wax is adhered to its interior. When the candle is relatively new, it is easy to light and keep burning since the flame is near the open top end. As the candle is used on several occasions, the wax level inside the jar gets lower making the wick more difficult to light unless long matchsticks or gas lighters are used. Also, the flame does not glow as brightly since the exposure to oxygen enriched air is more limited as the level goes down.

U.S. Pat. No. 6,065,960 of Hardy relates to a layered glass candle holder with a plurality of glass layers. As the candle within is consumed, ring layers can be removed to place the wick closer to the top open surface, but this is not the intent of the invention. Hardy's candle holder is mainly a decorative device which may have layers of different colors permitting the consumer to rearrange these at will. The candle is preferably spaced away from the inner walls of the ring layers, and there is no notion of a cohesive jar having compression fitted rings which can be factory filled with scented wax, except for a glued, non-adjustable alternate embodiment in Hardy's device. Hardy's joints are preferably complementary knobs and recesses, which would hold the rings laterally, but would not be as tight in the vertical axis as interchangeable compression fitted joints or threaded joints between the rings.

The prior art does not reveal an adjustable candle holder jar which can be factory filled with scented wax, sealed with a cover and have stacked compression fitted or threaded fitted rings in stages which can be removed to form an adjustable height candle holder.

### OBJECTS OF THE INVENTION

It is therefore an object of the present invention to provide a an adjustable candle holder jar which can be factory filled with scented wax, sealed with a cover and have stacked rings in stages which can be removed to form an adjustable height candle holder.

It is also an object of the present invention to provide an adjustable height container for consumable items, such as food.

It is also an object of the present invention to provide an adjustable height container for a collection of depletable items, such as hardware fasteners, where the height of the collection of items changes as the supply of items is exhausted during consumption or use.

Other objects which become apparent from the following description of the present invention.

### SUMMARY OF THE INVENTION

In keeping with these objects and others which may become apparent, the present invention is an adjustable height candle jar optionally sold with a candle, known in the trade as “STAGE GLOW CANDLE”™, which has a stack of accurately fitted rings forming the side atop a closed bottom section. The top ring is somewhat flared out and can accept a close fitted cap. The jar is intended to be factory filled with scented candle wax with a typical wick in the center.

In the preferred embodiment the jar of this invention can be manufactured of transparent or translucent and colored polycarbonate, VO or V2 polystyrene; its dimensions are a major diameter of approximately 4″ and a height of about 6.6″ to accommodate 20 ounces of wax. Other materials such as metal or glass can also be used.

It is noted that the jar is a stable structure as assembled with its various layers. Pouring hot wax inside creates a very robust package for transport and sales display after the wax solidifies; yet upper stages can be easily pulled off as the candle is consumed.

The same jar structure (perhaps in different sizes and height/diameter ratio) can be used to serve finger food items such as nuts, chips or candy. As the contents are consumed, upper layers are removed to facilitate easy reach down to the bottom of the jar. Even a collection of depletable items, such as hardware fasteners, can be likewise packaged, such as a jar of nails or screws, so that the user does not have to reach into the bottom of a tall jar to remove remaining items. Additionally, the jar can increase in size for items which are added in quantity, such as a collection of coins or other items which can increase in quantity over time.

### BRIEF DESCRIPTION OF THE DRAWINGS

The present invention can best be understood in connection with the accompanying drawings. It is noted that the invention is not limited to the precise embodiments shown in drawings, in which:

FIG. 1 is an upright perspective view of the adjustable height candle holder jar of this invention showing the open interior;

FIG. 2 is a perspective view of an inverted jar of FIG. 1 showing the closed bottom surface;

FIG. 3 is an exploded side elevation of the jar of this invention showing the various layers;

FIG. 4 is a side central crossection of an assembled jar;

FIG. 5 is a side view of a jar of this invention with a burning candle of a height compatible with a bottom and two intermediate stages;

FIG. 6 is a side view of the same candle after it has burned down to a height requiring only the base section; and,

FIG. 7 is a side view of an alternate threaded embodiment.

### DETAILED DESCRIPTION OF THE INVENTION

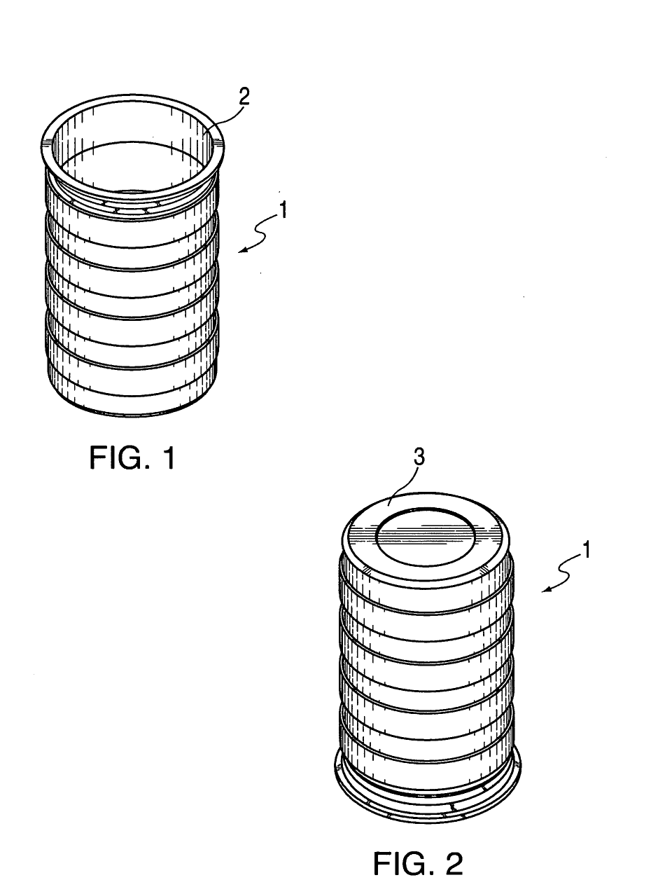

The adjustable height candle holder jar of this invention is shown in detail in FIGS. 1-6. It is shown in the configuration of the preferred embodiment, but variations in relative diameter/height ratio, decorative features, and number of intermediate stage rings can all be adjusted for particular applications without deviating from the salient features.

FIG. 1 shows jar 1 in an upright position showing an open top end with accessible interior 2.

FIG. 2 shows jar 1 in an inverted position showing its closed bottom surface 3.

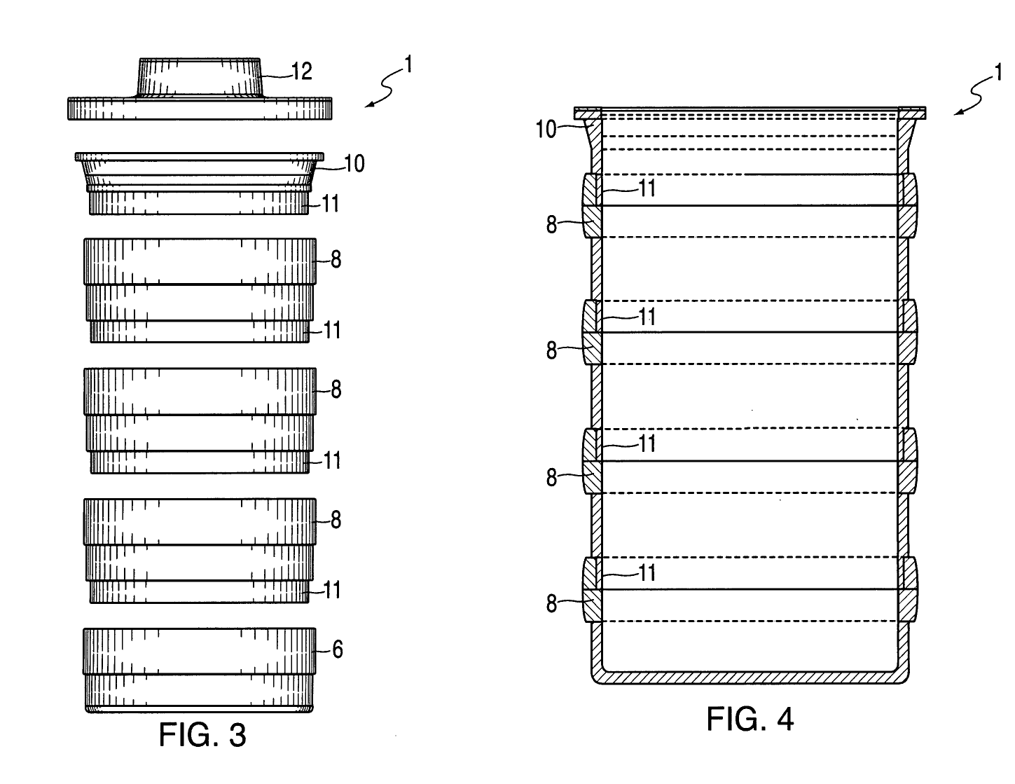

FIG. 3 shows an exploded view of jar 1 with optional cover 12. The slightly flared top ring 10 compression fits into the top of intermediate ring 8 by virtue of fitted sleeve extension 11. All three intermediate rings 8 fit into each other with there own sleeve extensions 11. Bottom intermediate ring 8 fits into sealed bottom section 6 with its sleeve extension 11. The fit of all sections (except cover 12) is shown in detail in the crossection of FIG. 4. The compression fitting forms a tight, but height adjustable jar about a vertical axis, with removable rings.

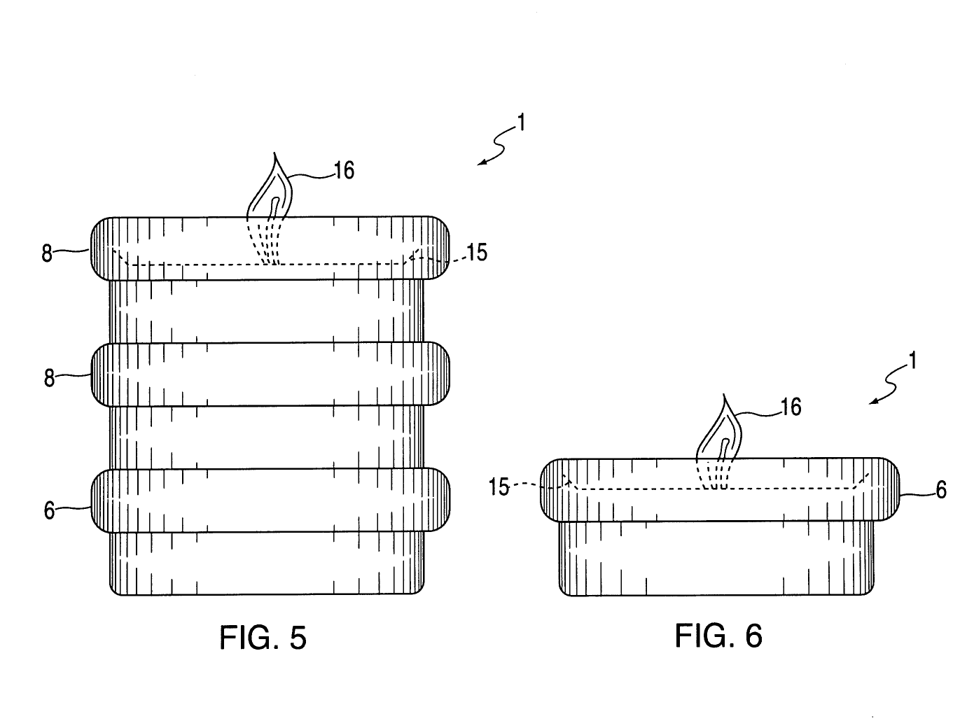

FIGS. 5 and 6 show two snapshots of a candle within the adjustable candle holder jar 1 of this invention as it is consumed from an intermediate size to a very low height.

In FIG. 5, two intermediate sections 8 atop bottom section 6 are shown serving a candle with wax level at dashed line 15. It is noted that a single wick with flame 16 is adjacent to the open top end; it is easy to blow out and relight. It also burns well being adjacent to a ready supply of fresh air. Instead of a single wick as shown in FIG. 5, it is further noted that optionally two or more wicks can be used to produce multiple flames 16. It is also noted that top intermediate section 8 can be replaced optionally by flared top ring 10 and further optionally with cover 12.

In FIG. 6, the candle has been consumed to such a low level that only bottom section 6 is used to house it, yet it still burns well after the two intermediate sections 8 from FIG. 5 are removed.

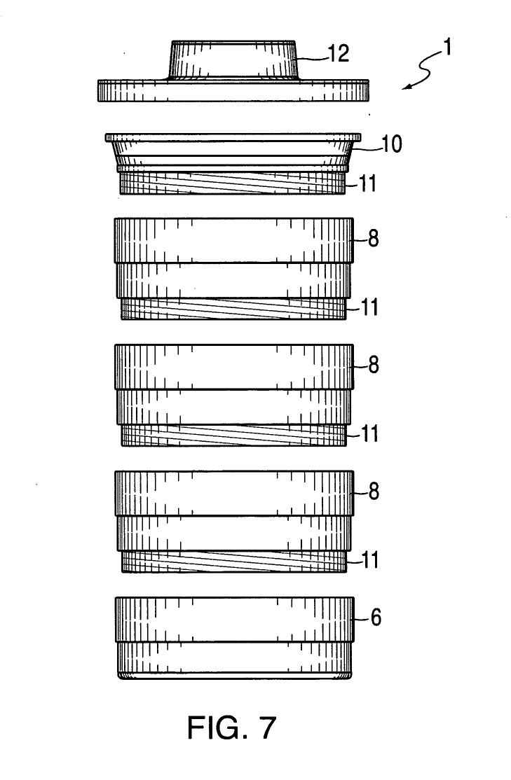

FIG. 7 shows an alternate embodiment using threaded joints 11 instead of compression fitted joints 11 between rings 8.

The aforementioned drawings show the jar 1 decreasing in size. This would be applicable for melting candles, or for a collection of depletable items, such as a collection of discrete food or hardware items. It is noted that the jar 1 can alternatively increase in size for items which increase their height in size, such as an increasing collection of change of coins which increases in height as more coinage is added.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. An adjustable candle holder jar comprising:
a plurality of stacked individual rings forming a jar containing a candle;
said rings including a bottom ring, a plurality of intermediate rings, and a top ring;
each intermediate ring having a lower sleeve extension fitting into an upper section of an underlying intermediate ring; and
said bottom ring comprising a flat bottom surrounded by an annular wall forming an open container for holding said candle, said annular wall including an upper section for receiving the lower sleeve extension of an intermediate ring forming said candle holder jar whose height may be adjusted by addition or removal of intermediate rings to compensate for different size candles and change in candle height during use.

2. The adjustable candle holder jar of claim 1 in which each intermediate ring comprises an outer annular wall made up of said lower sleeve extension, a central section and said upper section shaped to receive the lower sleeve extension of the intermediate ring directly above.

3. The adjustable candle holder jar of claim 2 having a downwardly facing and outwardly extending annular shoulder between each extension sleeve and the central section of each intermediate ring.

4. The adjustable candle holder jar of claim 3 having an upwardly facing and inwardly extending annular shoulder formed in said upper section located so that a bottom surface of the lower sleeve extension of an intermediate ring directly above rests on said inwardly extending annular shoulder and the downwardly facing shoulder of said intermediate ring directly above rests on an upper surface of said upper section forming said candle holder jar.

5. The adjustable candle holder jar of claim 4 in which the central section of each intermediate ring is of greater thickness than said sleeve extension, and the upper section is of greater thickness than said central section.

6. The adjustable candle holder jar of claim 5 in which said top ring has a flared upper opening to receive a cover for said jar.

7. The adjustable candle holder jar of claim 6 in which said rings are shaped to form a smooth inner vertical surface of said jar.

8. The adjustable candle holder jar of claim 7 in which said jar when fully assembled has an outer shape of alternating outer surfaces of said central and upper sections, said upper sections having an outer diameter larger than that of said central sections.

9. The adjustable candle holder of claim 1 wherein said fitting of said rings is a compression fitting.

10. The adjustable candle holder of claim 1 wherein said fitting of said rings is a threaded fitting.

11. An adjustable holder jar for a collection of items of depletable or additional quantity comprising:
a plurality of stacked individual rings forming a jar containing said collection of depletable items;
said rings including a bottom ring, a plurality of intermediate rings, and a top ring;
each intermediate ring having a lower sleeve extension fitting into an upper section of an underlying intermediate ring; and
said bottom ring comprising a flat bottom surrounded by an annular wall forming an open container for holding said collection of depletable items, said annular wall including an upper section for receiving the lower sleeve extension of an intermediate ring forming said holder jar for said collection of depletable items, whose height may be adjusted by addition or removal of intermediate rings to compensate for change in height of said collection of depletable items during use.

12. The adjustable holder jar for a collection of items of depletable or additional quantity of claim 11 in which each intermediate ring comprises an outer annular wall made up of said lower sleeve extension, a central section and said upper section shaped to receive the lower sleeve extension of the intermediate ring directly above.

13. The adjustable holder jar for a collection of items of depletable or additional quantity of claim 12 having a downwardly facing and outwardly extending annular shoulder between each extension sleeve and the central section of each intermediate ring.

14. The adjustable holder jar for a collection of items of depletable or additional quantity of claim 13 having an upwardly facing and inwardly extending annular shoulder formed in said upper section located so that a bottom surface of the lower sleeve extension of an intermediate ring directly above rests on said inwardly extending annular shoulder and the downwardly facing shoulder of said intermediate ring directly above rests on an upper surface of said upper section forming said adjustable holder jar for said collection of depletable items.

15. The adjustable holder jar for a collection of items of depletable or additional quantity of claim 14 in which the central section of each intermediate ring is of greater thickness than said sleeve extension, and the upper section is of greater thickness than said central section.

16. The adjustable holder jar for a collection of items of depletable or additional quantity of claim 15 in which said top ring has a flared upper opening to receive a cover for said jar.

17. The adjustable holder jar for a collection of items of depletable or additional quantity of claim 16 in which said rings are shaped to form a smooth inner vertical surface of said jar.

18. The adjustable holder jar for a collection of items of depletable or additional quantity of claim 17 in which said jar when fully assembled has an outer shape of alternating outer surfaces of said central and upper sections, said upper sections having an outer diameter larger than that of said central sections.

19. The adjustable holder jar for a collection of items of depletable or additional quantity of claim 11 wherein said collection of depletable items is a collection of consumable food items.

20. The adjustable holder jar for a collection of items of depletable or additional quantity of claim 11 wherein said collection of depletable items is a collection of usable hardware fasteners.

21. The adjustable holder jar for a collection of items of depletable or additional quantity as in claim 11 wherein said fitting is a compression fitting.

22. The adjustable holder jar for a collection of items of depletable or additional quantity as in claim 11 wherein said fitting is a threaded fitting.
